(19) United States
(12) Patent Application Publication
(10) Pub. No.: US 2008/0014016 A1
(43) Pub. Date: Jan. 17, 2008

(54) Fastening device for fastening an add-on part

(75) Inventors: Markus Keller, Leonberg (DE); Heinz-Arno Kruschhausen, Wiernsheim (DE)

Correspondence Address: LERNER GREENBERG STEMER LLP, P O BOX 2480, HOLLYWOOD, FL, 33022-2480, US

(73) Assignee: Dr. Ing. h.c. F. Porsche AG

(21) Appl. No.: 11/879,060

(22) Filed: Jul. 16, 2007

(30) Foreign Application Priority Data
Jul. 14, 2006 (DE) 10 2006 032 597.4

(51) Int. Cl. B60R 19/00; F16B 17/00

(52) U.S. Cl. 403/326; 296/193.09

(57) ABSTRACT

To positionally fix a front part of a motor vehicle to a support part fixed on the vehicle body, pre-fixing devices are provided via tabs which can be bent over and can be brought into a latching position on the support part. The front part can thereby be held in a manner such that it can be adjusted in a plurality of directions, and therefore pre-fixing is achieved.

### CROSS-REFERENCE TO RELATED APPLICATION

This application claims the priority, under 35 U.S.C. § 119, of German application DE 10 2006 032 597.4, filed Jul. 14, 2006; the prior application is herewith incorporated by reference in its entirety.

### BACKGROUND OF THE INVENTION

### Field of the Invention

The invention relates to a fastening device for fastening an add-on part of a motor vehicle, in particular for fastening a front part of a motor vehicle, to a support part fixed on the vehicle body, via latching connections.

German Utility Model DE 602 02 004 T2 discloses a connection of two plastic body parts, wherein a tongue is disposed at the edge of the one plastic part and an opening is disposed at the edge of the other plastic part, and a latching connection of the two body parts takes place via the tongue which is inserted into the opening.

### SUMMARY OF THE INVENTION

It is accordingly an object of the invention to provide a fastening device for fastening an add-on part which overcomes the above-mentioned disadvantages of the prior art devices of this general type, which makes it possible for the add-on part to be repeatedly precisely positioned in all installation directions on the support part fixed on the body, for securing purposes.

With the foregoing and other objects in view there is provided, in accordance with the invention, a fastening device for fastening an add-on part of a motor vehicle to a support part fixed on a vehicle body. The fastening device contains a plurality of latching connections disposed between the add-on part and the support part fixed on the vehicle body. The latching connections contain at least one tab having a film hinge with a pivoting axis for pivoting from the add-on part about said pivot axis and, in a fastening position, said tab having a free end with a latching edge for engaging behind a latching lug on the support part fixed on the vehicle body.

The advantages primarily obtained with the invention relate in that an add-on part, such as, for example, a front part of a motor vehicle, can be precisely positioned in a plurality of directions on a support part fixed on the vehicle body, and subsequently fastening can take place. This is achieved by a plurality of latching connections being provided between the add-on part and the support part fixed on the vehicle body, which latching connections contain at least one tab which can be pivoted from the add-on part via a film hinge with a pivot axis and, in a fastening position, engages by a latching edge at the free end of the tab behind a latching lug on the support part fixed on the vehicle body. In particular, the tab has a passage opening which has the latching edge which, after a pivoting operation, engages, in the fastening position, from above behind the latching lug on the support part fixed on the vehicle body. The effect thereby advantageously achieved is that the add-on part is held in an elastically positioned manner with respect to the support part by the tab such that it is possible to adjust the add-on part in the X and in the Z directions, i.e. in the longitudinal and vertical directions with respect to the vehicle.

In addition to the tab, webs protruding on the outer edge are provided on the add-on part, for positional fixing on the support part fixed on the vehicle body. The webs engage in slots of the support part fixed on the vehicle body, and the webs are disposed at least on both sides of a tab. The support part fixed on the vehicle body is fixedly connected, at the inner edge which faces away from the outer edge, to the add-on part via limbs. After final positioning of the add-on part on the support part, fastening takes place by a fixed connection, for example via the limbs on the support part, which can be connected to limbs on the add-on part.

The pivot axis of the film hinge is disposed in the outer edge of the support part and the passage opening of the tab is provided on the end side at the free end and the latching edge is angled to form an intermediate limb of the tab and engages behind a projection of the latching lug, which projection points towards the latching edge. The pivot axis of the film hinge lies precisely in the region of the edge of the support part, and therefore, in the fastening position of the tab, a stop is formed via the edge.

Other features which are considered as characteristic for the invention are set forth in the appended claims.

Although the invention is illustrated and described herein as embodied in a fastening device for fastening an add-on part, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, front view from an inside of a support part fixed on a vehicle body with an add-on part disposed in front of it, in a fastening position via a tab; and.

FIG. 2 is a diagrammatic, sectional view taken along the line II-II shown in FIG. 1 through a connecting point between the add-on part and the support part.

### DETAILED DESCRIPTION OF THE INVENTION

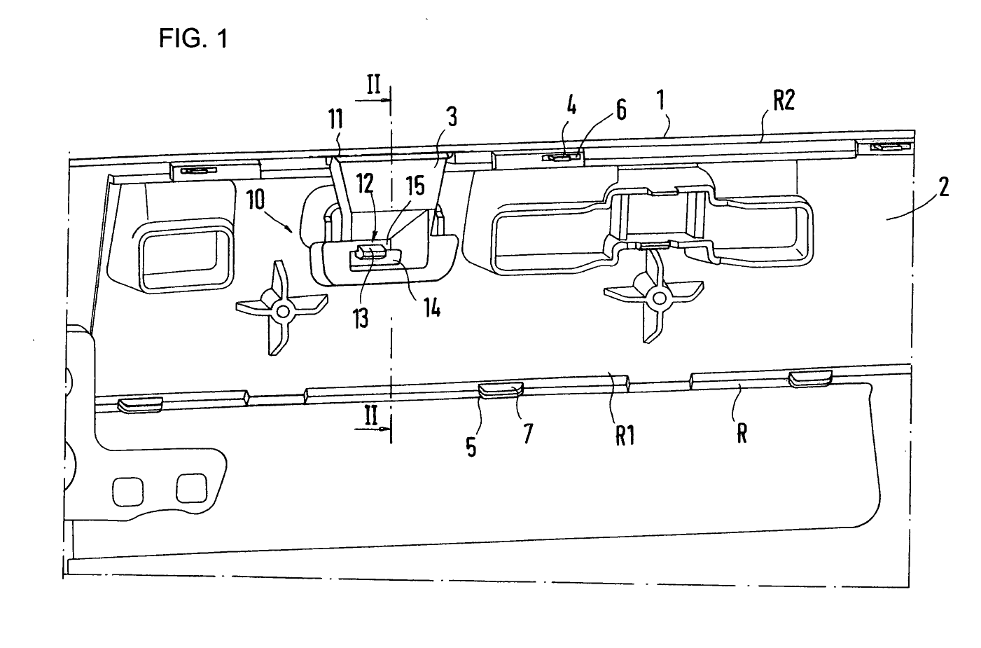

Referring now to the figures of the drawing in detail and first, particularly, to FIG. 1 thereof, there is shown a fastening device for fastening an add-on part 1 or for fastening a front part of a motor vehicle to a support part 2 fixed on the vehicle body. The fastening device includes, inter alga, tabs 3, webs 4 and limbs 5 on the add-on part 1, and slots 6 and limbs 7 on the support part 2 fixed on the vehicle body.

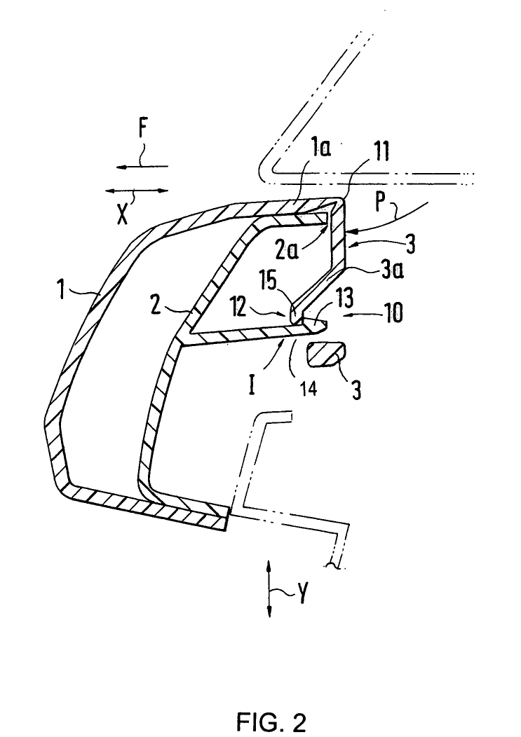

To position the add-on part 1 in the X-direction and the Y-direction of the vehicle, one or more latching connections 10 is or are provided between the add-on part 1 and the support part 2. The latching connections 10 contain the tab 3 which can be pivoted by a film hinge about a pivot axis 11. In a fastening position I (see FIG. 2), the tab 3 engages by use of its free end 12 behind a latching lug 13 on the support part 2.

In the fastening position I, the tab 3 is bent over through approximately 90° with respect to the add-on part 1 and an edge 2a of the support part 2 bears in the corner between tab 3 and upper add-on part 1a and can be supported there.

As can be seen in more detail in FIG. 1, the add-on part 1 is additionally fixed and held via webs 4 which engage in corresponding slots 6 of the support part 2. Furthermore, in order to fasten the add-on part 1 to the support part 2, limbs 5 and 7 are disposed on a lower edge R1 and R of the add-on part 1 and of the support part 2, which limbs 5, 7 respectively protrude from the edge R and R1 and are connected fixedly to each other.

The tab 3 is provided with a passage opening 14 which forms in the opening 14 a latching edge 15 which engages behind the latching lug 13 in the support part 2 in the fastening position I, as illustrated in more detail in FIG. 2.

The pivot axis 11 of the film hinge is disposed in an outer edge R2 of the add-on part 1, with the passage opening 14 of the tab 3, with the latching edge 15 on the end side of the tab 3, being provided in the vicinity of the free end. The latching edge 15 is angled from an intermediate limb 3a of the tab 3, and, after a pivoting movement in an arrow direction P, the latching edge 15 can engage behind the latching lug 13 on the support part 2.

The elastic stressing of the bent-over tab 3 secures the latching edge 15 on the latching lug 13.

1. A fastening device for fastening an add-on part of a motor vehicle to a support part fixed on a vehicle body, the fastening device comprising:
a plurality of latching connections disposed between the add-on part and the support part fixed on the vehicle body, said latching connections containing at least one tab having a film hinge with a pivoting axis for pivoting from the add-on part about said pivot axis and, in a fastening position, said tab having a free end with a latching edge for engaging behind a latching lug on the support part fixed on the vehicle body.

2. The fastening device according to claim 1, wherein said tab has a passage opening formed therein and partially delimited by said latching edge, said tab after a pivoting operation in a given direction engages, in the fastening position, with said latching edge from behind the latching lug on the support part fixed on the vehicle body.

3. The fastening device according to claim 1, further comprising:
webs disposed on the add-on part and protruding from an outer edge, for positional fixing on the support part fixed on the vehicle body, said webs engaging in slots of the support part fixed on the vehicle body and said webs being disposed at least on both sides of said tab; and
limbs disposed on an inner edge of the the support part facing away from said outer edge, said limbs connected fixedly to the add-on part.

4. The fastening device according to claim 2, wherein:
said pivot axis of said film hinge is disposed in a region of an outer edge of the support part;
said passage opening in said tab is disposed on an end side at said free end; and
said latching edge is angled to form an intermediate limb of said tab and engages behind a projection of the latching lug, and the projection points towards said latching edge.

5. The fastening device according to claim 1, wherein the add-on part is a front part of the motor vehicle.
